(19) United States
(12) Patent Application Publication
(10) Pub. No.: US 2019/0114600 A1
(43) Pub. Date: Apr. 18, 2019

(54) METHOD AND SYSTEM FOR MANAGING A SOCIAL VALUE OF A USER ACCOUNT

(71) Applicant: Thomas Ashley, Flourtown, PA (US)

(72) Inventor: Thomas Ashley, Flourtown, PA (US)

(21) Appl. No.: 16/007,101

(22) Filed: Jun. 13, 2018

Related U.S. Application Data
(60) Provisional application No. 62/573,793, filed on Oct. 18, 2017.

(51) Int. Cl. G06Q 20/10; G06Q 50/00

(52) U.S. Cl. CPC G06Q 20/10; G06Q 50/01

(57) ABSTRACT

Disclosed is a method of managing a social value of at least one social user account. The method may include receiving, using a communication device, a request to obtain a stock in a social value associated with a first user account. Further, the request may be received from a second user device associated with a second user account. Further, the method may include assigning, using a processing device, a portion of the social value of the first user account to the second user account based on the request. Further, the method may include determining, using the processing device, earnings associated with the first user account. Further, the method may include transferring, using the processing device, a dividend to the second user account based on the earnings associated with the first user account.

The current application claims a priority to the U.S. Provisional Patent application Ser. No. 62/573,793 filed on Oct. 18, 2017.

### FIELD OF THE INVENTION

The present invention relates generally relates to the field of data processing. More specifically, the present invention relates to managing of a social value of a user account associated with a social network.

### BACKGROUND OF THE INVENTION

Due to advancements in digital technology and widespread connectivity to the Internet in particular, a large number of users are spending a substantial time of their lives online. Users are increasingly turning to the digital world for their daily needs, be it for news, entertainment or specific information. Accordingly, several developments have been made to enhance the experience of users within the digital world. For example, several social media platforms exist today that facilitate users to consume digital content and interact with other users across the globe in an unprecedented manner. Additionally, social media platforms have also triggered an explosion in the number of user-generated content, such as images, videos, tweets, memes, posts and so on.

Further, while users engage in online activities, often there is an explicit and/or implicit generation of value as a result of these online activities. For example, users of a knowledge forum who provide answers/solutions to questions/problems posed by other users are creating value. Accordingly, existing online platforms attempt to motivate such value generation by rewarding users with recognition (stars, medals, designations etc.), points, credits, gift coupons, crypto-currency, money, etc.

However, there are several deficiencies in existing online platforms with regard to increasing user engagement. For instance, while users may be simultaneously active on several online platforms, activities performed by a user on one online platform is generally inaccessible to other online platforms. Accordingly, users may not be able to leverage a value created on one online platform on other online platforms. Further, existing online platforms do not take into account offline activities performed by users that may be relevant to and/or associated with online activities. Moreover, while existing online platforms enable users to generate and accrue value, they do not provide users with any initial value based on prior factors such as the background of users, past experience, qualifications etc.

Therefore, there is a need for improved methods and system for managing of the social value of one or more social user accounts that may overcome one or more of the abovementioned problems and/or limitations.

### SUMMARY OF THE INVENTION

This summary is provided to introduce a selection of concepts in a simplified form that are further described below in the Detailed Description. This summary is not intended to identify key features or essential features of the claimed subject matter. Nor is this summary intended to be used to limit the claimed subject matter's scope.

According to some embodiments, an online platform, a method and a system are provided that facilitate managing of a social value of one or more social user accounts. Accordingly, a user may register on the online platform (e.g. a social media application) which may assign a social value to a social media account associated with the user. In an instance, the online platform may evaluate a profile and/or associated online activities and/or offline activities of the user in order to compute the social value. Accordingly, in some embodiments, the online platform may also communicate with third-party platforms (on which the user may perform activities) in order to calculate the social value associated with the user. Further, at least a portion of the social value of the user may be distributed to one or more other users who may be termed to hold a “stock” in the social value of the user. Accordingly, in some instances, an earning associated with the social value may be distributed to the one or more other users in accordance with an extent of corresponding stock held by the one or more other users.

In some embodiments, a method of managing a social value of at least one social user account is disclosed. The method may include receiving, using a communication device, a request to obtain a stock in a social value associated with a first user account. Further, the request may be received from a second user device associated with a second user account. In an instance, the request may include details such as, for example, number of stocks or shares that a second user associated with the second user account wishes to buy. Further, in some instances, the online platform may limit a total number and/or value of stocks that are available for buying. In an instance, the value of stocks available for buying may be equivalent to 49% of the total value of stocks (i.e. 49% of the social value).

Further, the method may include assigning, using a processing device, a portion of the social value of the first user account to the second user account based on the request. In an instance, the online platform may receive a payment from the second user associated with the second user account in exchange for the stocks purchased. For example, out of the available 50 shares of stock in the social value of the first user, the second user may request to buy 10 shares. Further, in some embodiments, the online platform may require an authorization from the first user in order to effect transfer of shares associated with the first user's social value to the second user account. Accordingly, the online platform may transmit the request to the user device of the first user. Further, the online platform may be configured to receive an authorization from the user device of the first user. Accordingly, based on the authorization, the online platform may facilitate transfer of shares to the second user account.

Further, the method may include determining, using the processing device, earnings associated with the first user account. In an instance, the earnings may be obtained based on online activities (e.g. answering questions on a knowledge forum, viewing paid advertisements, undertaking paid surveys, providing paid reviews etc.) and/or offline activities (e.g. attending an event, participating in a walkathon, etc.) performed by the first user. Alternatively, in some embodiments, the earnings may be obtained based on dividends associated with stocks in social value of a third user (or a plurality of third users) that is held by the first user.

Further, the method may include transferring, using the processing device, a dividend to the second user account based on the earnings associated with the first user account. Further, the dividend may also depend on an extent of stock in the social value of the first user account held by the second user account.

According to some embodiments, a system for managing a social value of at least one social user account is disclosed. The system may include a communication device configured for receiving a request to obtain a stock in a social value associated with a first user account. Further, the request may be received from a second user device associated with a second user account. Further, the system may include a processing device configured for assigning a portion of the social value of the first user account to the second user account based on the request. Further, the processing device may be configured for determining earnings associated with the first user account. Further, the processing device may be configured for transferring a dividend to the second user account based on the earnings associated with the first user account.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of a platform consistent with various embodiments of the present disclosure.

FIG. 2 is a flowchart of a method of managing a social value of one or more social user accounts including assigning a stock in the social value of a first user account to a second user account, in accordance with some embodiments.

FIG. 3 is a flowchart of a method of managing a social value of a user account based on monitoring of activity of the first user associated with the first user account, in accordance with some embodiments.

FIG. 4 is a flowchart of a method of managing a social value of one or more social media accounts including selling of a stock in a social value of a first user account held by a second user account, in accordance with some embodiments.

FIG. 5 is a flowchart of a method of managing a social value of one or more social user accounts including allowing one or more users to communicate, in accordance with some embodiments.

FIG. 6 is a flowchart of a method of managing a social value of one or more social user accounts including adding an advertisement to a profile of a user and providing earnings based on views of the profile and/or the advertisement by other users, in accordance with some embodiments.

FIG. 7 is an exemplary visualization of managing of the social value of one or more social user accounts based on sensor data corresponding to a user activity, in accordance with some embodiments.

FIG. 8 is a block diagram of a computing device for implementing the methods disclosed herein, in accordance with some embodiments.

FIG. 9 illustrates a user interface of a mobile application for managing the social value of one or more user accounts, in accordance with some embodiments.

FIG. 10 illustrates a user interface of the mobile application displaying a tag cloud depicting keywords, in accordance with some embodiments.

FIG. 11 illustrates a user interface of the mobile application displaying a user profile based upon the search query, in accordance with exemplary embodiments.

FIG. 12 illustrates a user interface of the mobile application displaying a timeline of a user, in accordance with exemplary embodiments.

FIG. 13 illustrates a user interface of the application displaying an option to trade social stocks in a user, in accordance with some embodiments.

FIG. 14A illustrates a user interface showing a preview page for trading, in accordance with some embodiments.

FIG. 14B illustrates a user interface showing a buy page for trading, in accordance with some embodiments.

FIG. 14C illustrates a user interface showing an order confirmation page for trading, in accordance with some embodiments.

FIG. 14D illustrates a user interface showing a sell page for trading, in accordance with some embodiments.

FIG. 14E illustrates a user interface showing an order confirmation page for trading, in accordance with some embodiments.

FIG. 15 illustrates a user interface of the application for filtering search results, in accordance with some embodiments.

FIG. 16 illustrates a user interface of the application for displaying results based on applying a filter, in accordance with some embodiments.

FIG. 17 illustrates a user interface containing a login page, in accordance with some embodiments.

FIG. 18 illustrates a user interface containing a registration page for registering a new user, in accordance with some embodiments.

FIG. 19A illustrates a user interface containing a registration page for registering the new user, in accordance with some embodiments.

FIG. 19B illustrates a user interface containing a registration page with a keywords field, in accordance with some embodiments.

FIG. 19C illustrates a user interface containing a registration page allowing users to go public, in accordance with some embodiments.

FIG. 20 illustrates a user interface containing a registration page allowing users to upload user photo, in accordance with some embodiments.

FIG. 21 illustrates a user interface of the application for optimizing user search based on adding user tags, in accordance with some embodiments.

FIG. 22 illustrates a user interface of the application for sending an instant message to a user based on bidding and social stock value, in accordance with some embodiments.

FIG. 23A illustrates a user interface of the application for sending an instant message to a user based on bidding and social stock value, in accordance with some embodiments.

FIG. 23B illustrates a user interface of the application for sending an instant message to a user based on bidding and social stock value, in accordance with some embodiments.

FIG. 23C illustrates a user interface of the application for keeping an instant message, in accordance with some embodiments.

FIG. 24 illustrates a user interface of the application for viewing recent user conversations, in accordance with some embodiments.

FIG. 25 illustrates a user interface of the application for viewing watch list associated with user profiles, in accordance with some embodiments.

FIG. 26A illustrates a user interface of the application for viewing account balance associated with a user account, in accordance with some embodiments.

FIG. 26B illustrates a user interface of the application for viewing account balance associated with a user account, in accordance with some embodiments.

FIG. 27 illustrates a user interface of an application displaying a market where users may go to watch advertisements, in accordance with some embodiments.

FIG. 28 illustrates user interface of an application displaying a self-serve process page that an advertiser may use to place advertisements on the system, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of social networking, embodiments of the present disclosure are not limited to use only in this context.

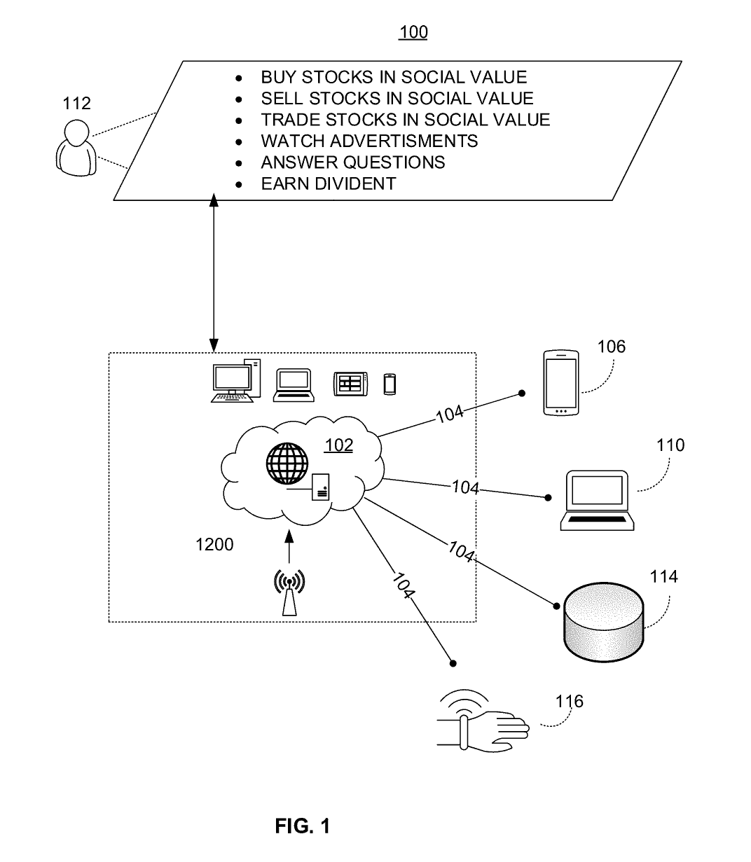

FIG. 1 is an illustration of a platform consistent with various embodiments of the present disclosure. By way of non-limiting example, the online platform 100 for managing a social value of one or more social user accounts may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114 (e.g. a bank database, other online platforms etc.), and monitoring devices 116 (e.g. fitness band, surveillance or drone cameras) etc., over a communication network 104, such as, but not limited to, the Internet. Further, users of the platform may include relevant parties such as one or more of students, professionals, etc. Accordingly, electronic devices operated by the one or more relevant parties may be in communication with the platform. For example, the mobile device 106 may be operated by a lawyer who may be rewarded for answering a query related to judicial system on the online platform that enables users to counsel with attorneys online.

A user 112, such as the one or more relevant parties, may access platform 100 through a web-based software application or browser. The web-based software application may be embodied as, for example, but not be limited to, a website, a web application, a desktop application, and a mobile application compatible with a computing device 800.

According to some embodiments, the online platform may facilitate managing of a social value of one or more social user accounts. Accordingly, a user may register on the online platform (e.g. a social media application) which may assign a social value to a social media account associated with the user. In an instance, the online platform may evaluate a profile and/or associated online activities and/or offline activities of the user in order to compute the social value. Accordingly, in some embodiments, the online platform may also communicate with third-party platforms (on which the user may perform activities) in order to calculate the social value associated with the user. Further, at least a portion of the social value of the user may be distributed to one or more other users who may be termed to hold a “stock” (also referred to herein as a “social stock” or “share”) in the social value of the user. Accordingly, in some instances, an earning associated with the social value may be distributed to the one or more other users in accordance with an extent of corresponding stock held by the one or more other users.

In some embodiments, the social stocks may be represented by a social stock price. The social stock price may either represent the stock price of a share and/or a number of shares that are available for buying. Accordingly, in an instance, the online platform may provide an option for other registered users to purchase stocks and/or shares associated with an individual who is also registered on the online platform. For example, the online platform may provide an option wherein a second registered user can buy stocks in a first registered user (e.g. a software engineer). Further, the second registered user may accordingly receive dividends whenever the first registered user performs an online activity, such as, for example, uploading a video lecture on the topic “big data analysis”, which results in increasing the social value corresponding to the first registered user.

Further, in an embodiment, the online platform may provide a trading environment wherein the users may buy and/or sell the social stocks associated with accounts of users registered on the online platform. For example, if the second registered user has bought social value in the first registered user, then the second registered user may have an option to sell the stocks purchased in the first registered user to a third registered user. Accordingly, in an instance, the online platform may operate as a social stock market.

Further, the online platform may analyze activities performed by a registered user and accordingly update the social value of the registered user. For example, the social value associated with a first registered user (e.g. a lawyer) may increase if the first registered user (e.g. lawyer) answers a query (e.g. a query related to the judicial system) on the online platform (or another platform in communication with the online platform). Further, the online platform may transfer a pre-determined portion of the first registered user's earning to social media accounts associated with one or more other users who have purchased stocks in the social media account of the first registered user (e.g. lawyer).

In an exemplary scenario, the online platform may assign a social value equivalent to $1000 to a first user account associated with a first user, wherein $10 may be the value of one share that is available for buying. Further, a second user may buy a portion of the social value associated with the first user account. Accordingly, the second user may decide to buy stocks worth $200, which may be equivalent to buying 20 shares. Further, the first user may perform an activity on the online platform (or any other platform e.g. a social media network in communication with the online platform) that yields an earning. Further, the earning may be divided into two parts. Accordingly, a first part of the earning may be assigned to the first user account while a second part of the earning may be assigned as a dividend to the second user account. The second part of the earning may be based on an extent of stocks that the second user account holds in the first user account.

Accordingly, in some embodiments, the online platform may be configured to communicate, using a communication device, with other online platforms. Further, the other online platforms may allow the plurality of users to register themselves and perform online activities that are associated with a creating a value. For example, a first online platform may communicate with a second online platform, which is a blogging platform. The second online platform may be used by registered users for publishing a blog. Accordingly, the first online platform may track an online activity (associated with a registered user) performed on the second online platform and assign and/or update the social value associated with the first online platform. In an instance, the social value may be updated whenever a user publishes a blog on the second online platform and audience views the published blog. Further, the audience may be registered as well as non-registered users.

Further, according to some embodiments, the online platform may be configured to communicate, using the communication device, with monitoring devices, such as, for example, wearable sensors like fitness bands. Accordingly, the online platform may gather sensor data associated with activities performed by a user (online and/or offline activities) and update the social value associated with a user account of the user. Accordingly, in an instance, integration of the online platform with wearable sensors like fitness band may assist in the tracking of offline activities and accordingly updating social values of users. For example, the online platform may track the offline activity of a first registered user, such as participation in a marathon. In an instance, a second registered user may have bought stocks in the first registered user, who may be an athletic professional. Further, the athletic professional may be participating in the marathon. Accordingly, the online platform may track details such as, speed and rank of the athletic professional etc. Further, the online platform may reward the athletic professional based upon the performance of the athletic professional in the marathon. Accordingly, the reward may update the social value (e.g. social stock price) on the online platform. Further, earning gained from rewards for participating and/or winning the marathon may be proportionately divided (based on the extent of shares sold to the second user) between the first registered user as well as the second registered user.

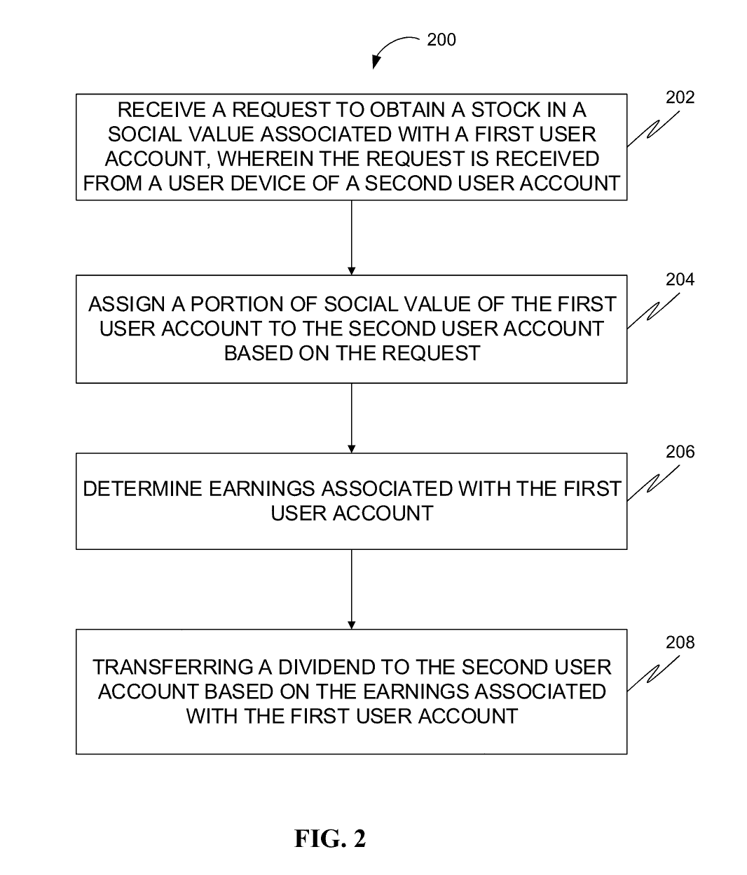

FIG. 2 is a flowchart of a method 200 of managing a social value of one or more social user accounts including assigning a stock in the social value of a first user account to a second user account, in accordance with some embodiments.

At 202, the method 200 may include a step of receiving, using the communication device, a request to obtain a stock in a social value associated with a first user account, wherein the request is received from a user device of a second user account. In an instance, the request may include details such as, for example, number of shares that the second user wants to buy in the first user. Further, the online platform 100 may limit a total value of stocks that are available for buying. In an instance, the value of stocks available for buying may be equivalent to 49% of the total value of stocks. Further, in an embodiment, the second user may request to buy stocks in the first user who is an influencer, such as, a celebrity, on the online platform 100.

Further, at 204, the method 200 may include a step of assigning, using a processing device, a portion of the social value of the first user account to the second user account based on the request. In some embodiments, the portion of the social value of the first user account may be limited to a predefined level. In an instance, the online platform 100 may receive payment from the second user associated with the second user account in exchange for the stocks purchased in the first user. For example, out of the available 50 shares of stock in the social value of the first user, the second user may request to buy 10 shares.

In some embodiments, the method 200 may further include transmitting, using the communication device, the request to the first user device associated with the first user account. Further, the method 200 may include receiving, using the communication device, an authorization from the first user device. Further, assigning (at 204) the portion of the social value of the first user account to the second user account may be further based on the authorization. Accordingly, in some embodiments, the online platform 100 may require an authorization from the first user in order to effect transfer of shares associated with the first user's social value to the second user account. Accordingly, the online platform 100 may transmit the request to the user device of the first user. Further, the online platform 100 may be configured to receive an authorization from the user device of the first user. Accordingly, based on the authorization, the online platform 100 may facilitate the transfer of shares to the second user account.

Further, at 206, the method 200 may include a step of determining, using the processing device, earnings associated with the first user account. In an instance, the earnings may be obtained based on online activities (e.g. answering questions on a knowledge forum, viewing paid advertisements, undertaking paid surveys, providing paid reviews etc.) and/or offline activities (e.g. attending an event, participating in a walkathon, etc.) performed by the first user. Alternatively, in some embodiments, the earnings may be obtained based on dividends associated with stocks in the social value of a third user (or a plurality of third users) that is held by the first user.

Further, at 208, the method may include a step of transferring, using the processing device, a dividend to the second user account based on the earnings associated with the first user account. Further, the dividend may also depend on an extent of stock in the social value of the first user account held by the second user account.

In an instance, the second user who has purchased the stocks in the first user may receive 25% of the earnings. In an exemplary scenario, if the earnings made by the first user account is equal to $10, then the 75% of the earning ($7.5) may be added to the first user account and the remaining 25% of the earning ($2.5) may be added to the second user account.

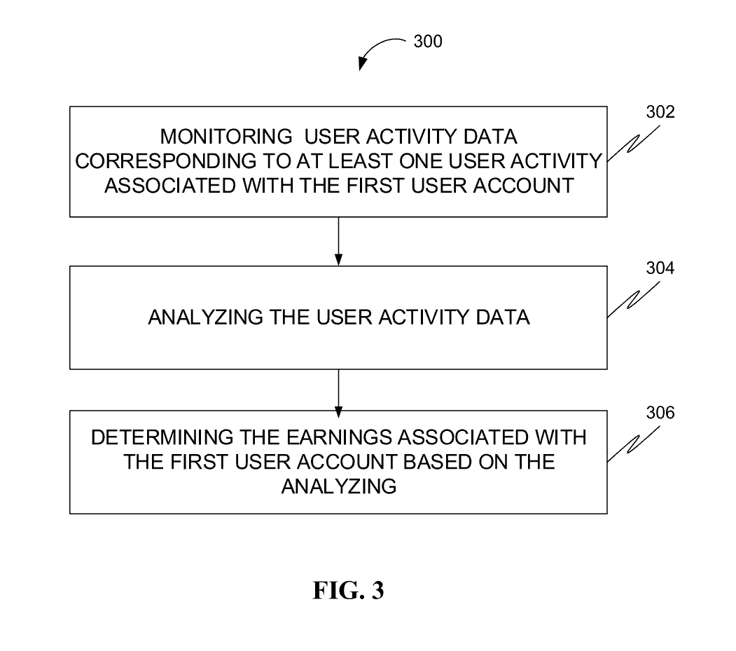

FIG. 3 is a flowchart of a method 300 of managing a social value of a user account based on monitoring of activity of the first user associated with the first user account, in accordance with some embodiments.

At 302, the method 300 may include a step of monitoring, using the processing device, user activity data corresponding to at least one user activity associated with the first user account. The at least one user activity may include at least one of an online activity and an offline activity. In an instance, the online platform 100 may monitor activities that are performed by the first user in online as well as offline modes. For example, the online platform 100 may monitor the user activity wherein the first user may conduct an advertisement campaign on various other social media platforms.

Accordingly, the first user may share campaign related information, such as, for example, campaign brochure, campaign theme, campaign itinerary, campaign photos, campaign testimonials and campaign videos etc. in order to advertise the campaign online. Further, the online platform 100 may track all user activities performed by the first user for the advertisement campaign. In further embodiments, the method 300 may include receiving, using the communication device, the user activity data from a wearable device associated with the first user account

At 304, the method 300 may include a step of analyzing, using the processing device, the user activity data.

Further, at 306, the method 300 may include a step of determining, using the processing device, earnings associated with the first user account based on the analyzing. In an instance, the online platform 100 may analyze the user activity and assign and/or update the social value associated with the first user account. Accordingly, the online platform 100 may employ an algorithm that calculates a “Social Stock Price” or “Social Value” based on a user's activities. For example, the online platform 100 may increase the social stock price by 1% whenever the first user shares a campaign photo associated with the advertising of the campaign on two social media platforms. Further, the online platform 100 may evaluate the earnings and accordingly update the social value (e.g. the social stock price) associated with the first user account. In an instance, the earnings may also come from advertisers. For example, the earnings may be made by viewing the advertisements on the online platform 100 and/or other platforms in communication with the online platform 100.

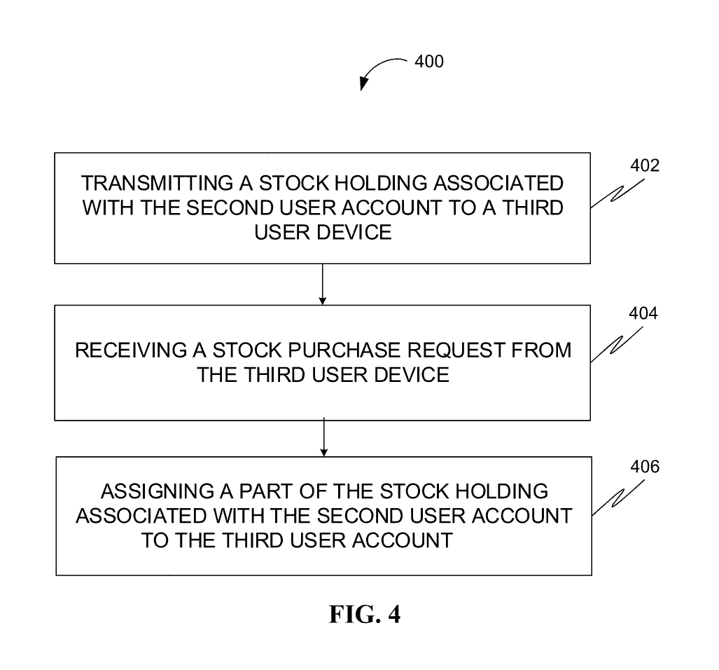

In some embodiments, a method of managing a social value of a user account based on monitoring of user activity may include monitoring, using the processing device, user activity data corresponding to at least one user activity associated with the first user account. The method may further include analyzing, using the processing device, the user activity data. Further, the method may include generating, using the processing device, an updated social value based on the analyzing and the social value associated with the first user account. The method may further include storing, using a storage device, the updated social value in association with the first user account. FIG. 4 is a flowchart of a method 400 of managing a social value of one or more social media accounts including selling of a stock in a social value of a first user account held by a second user account, wherein the stock is sold to a third user account, in accordance with some embodiments.

At 402, the method 400 may include a step of transmitting, using the communication device, a stock holding associated with the second user account to a third user device. Accordingly, in an instance, the online platform 100 may allow selling of stocks to a third party (e.g. a registered user, who is not directly involved with the first user). Accordingly, the third user may want to buy stocks in a first user from the second user.

Further, at 404, the method 400 may include a step of receiving, using the communication device, a stock purchase request from the third user device. The stock purchase request may be associated with the stock holding. In an instance, the stock purchase request may include a permission to authorize the selling of social stocks to the third user. Further, the stock purchase request may also include specific details such as, for example, the number of shares requested by the third user.

Further, at 406, the method 400 may include a step of assigning, using the processing device, a part of the stock holding associated with the second user account to the third user account associated with the third user device. In an instance, the online platform 100 may accept a payment form the third user account in exchange for the social stocks purchased in the first user. In an exemplary scenario, the third user buys the social stocks worth $100 in the first user from the second user who may initially hold $200 worth of stock in the social value of the first user.

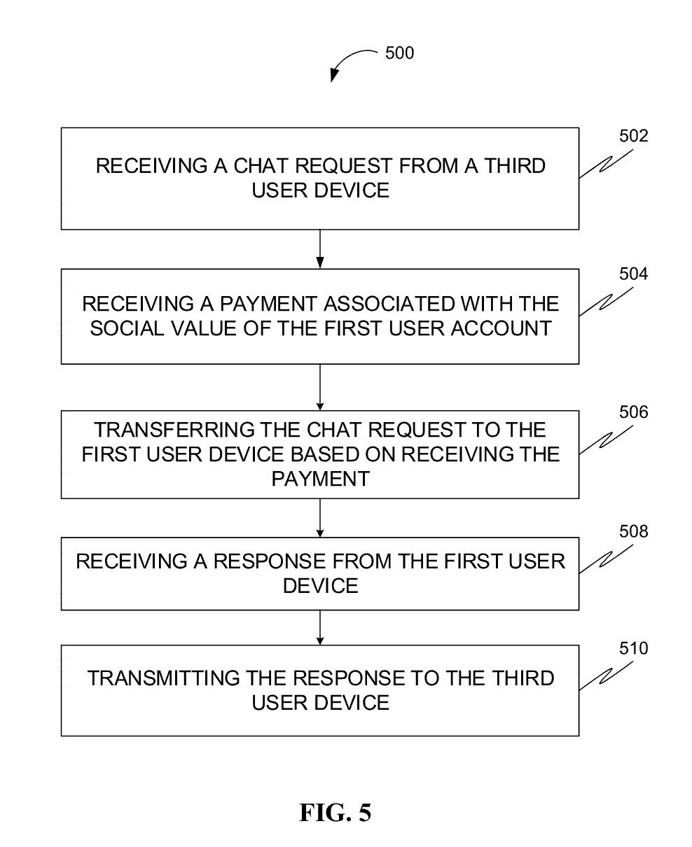

FIG. 5 is a flowchart of a method 500 of managing a social value of one or more social user accounts including allowing one or more users to communicate, in accordance with some embodiments.

At 502, the method 500 may include a step of receiving, using the communication device, a chat request from a third user device. The chat request may be directed to the first user associated with the first user account. Further, the chat request may include details, such as, for example, name, subject of conversation, and query asked by the third user.

Further, at 504, the method 500 may include a step of receiving, using the communication device, a payment associated with the social value of the first user account. Further, the payment may be received from the third user device. Accordingly, the first user may monetize their time on a social media platform by performing activities, such as, for example, by reading and responding to messages sent by other users (e.g. the third user) of the social media platform. In an instance, the third user may make a payment associated with an amount equivalent to the social stock price of the first user account in order to chat with the first user. In an exemplary scenario, a user A may elect to contact a user B via instant messaging (e.g. chat). Accordingly, the user A may pay the “Social Value” or “Social Stock Price” associated with the social media account of the user B. Further, as an example, if the user B's stock price is $5.00, then the user B may receive 50% or $2.50 for reading the message and another 50% or $2.50 for responding to the message. Further, in an embodiment, if the user B does not read or respond to the message, then the $5.00 may be refunded to the social media account associated with user A. If the user B reads the message but does not respond, then only 50% or $2.50 may be refunded to the social media account associated with the user A.

Further, at 506, the method 500 may include a step of transferring, using the communication device, the chat request to the first user device based on receiving the payment. In an instance, the first user device may receive a notification in the form of an SMS. Accordingly, the first user may be alerted about the chat request sent by the third user. Further, the first user may appropriately respond to a message received in the chat request.

Further, at 508, the method 500 may include a step of receiving, using the communication device, a response from the first user device. Accordingly, at 510, the method 500 may include a step of transmitting, using the communication device, the response to the third user device. In an instance, the third user may be alerted about the response received from the first user in the form of an SMS.

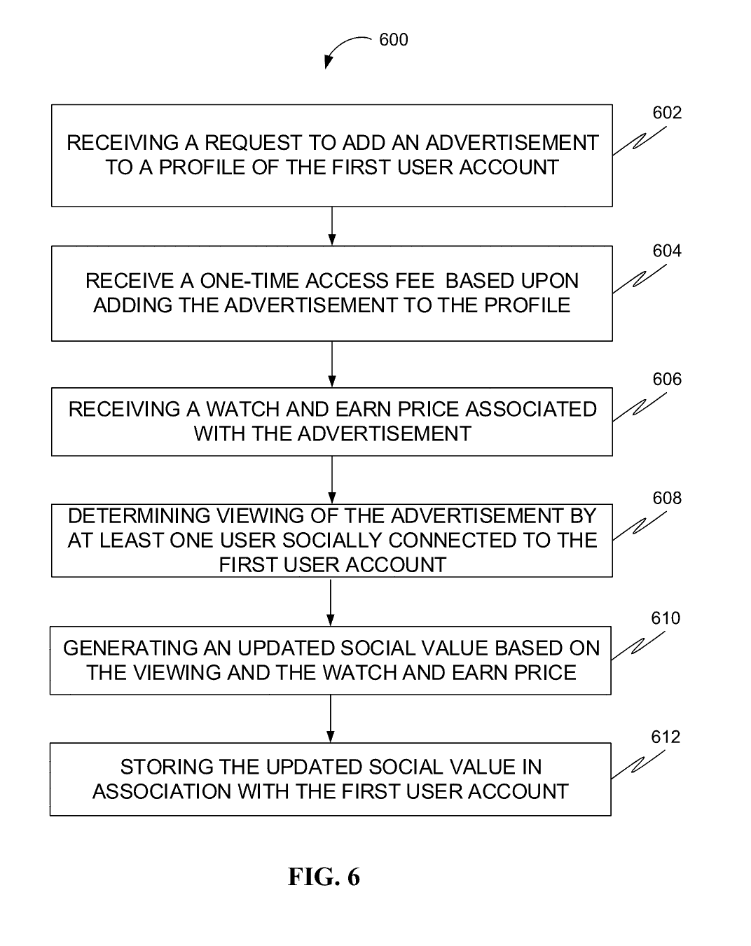

FIG. 6 is a flowchart of a method 600 of managing a social value of one or more social user accounts including adding an advertisement to a profile of a user and providing earnings based on views of the profile and/or the advertisement by other users, in accordance with some embodiments.

At 602, the method 600 may include a step of receiving, using the communication device, a request to add an advertisement to a profile of the first user account. In an instance, registered users may monetize their time on the online platform 100 by viewing and/or posting advertisements on their social media profiles for advertising purposes. Accordingly, the social value and/or the social stock price associated with a user account may increase if the users view already posted advertisements and/or post a new advertisement on their profile feeds.

Further, at 604, the method 600 may include a step of receiving, using the communication device, a one-time access fee based upon adding the advertisement to the profile. In an instance, advertisers may pay a one-time fee to the users who wish to earn by posting the advertisements on their profile feeds.

At 606, the method 600 may include a step of receiving, using the communication device, a watch and earn price associated with the advertisement. In an instance, the advertisers may select a watch and earn price that they are willing to pay to each user who views the advertisement. For example, the advertisers may pay every user $0.5 if the user views the video from their social media accounts. In an embodiment, the advertisers may limit how many times an individual user can watch a given advertisement. In an instance, the earning made by viewing the advertisements may reflect in the user's social stock price and/or the social value. Accordingly, the social stock price associated with a user account may increase if the user views the advertisement on the online platform 100.

Further, at 608, the method 600 may include a step of determining, using the processing device, viewing of the advertisement by at least one user socially connected to the first user account.

Further, at 610, the method 600 may include a step of generating, using the processing device, an updated social value based on the viewing and the watch and earn price.

Further, at 612, the method 600 may include a step of; and storing, using a storage device, the updated social value in association with the first user account.

In an embodiment, the advertisers may also offer an additional income to the users who elect to place the advertisements in their profile feeds. For example, the advertisers may pay two dollars ($2) to a user who uploads an advertisement on their profile feeds. In addition to this, the advertisers may also subsequently pay bonuses to the users who upload the advertisements whenever other users views the advertisements from the user's profile feeds.

According to some embodiments, a system for managing a social value of at least one social user account is disclosed. The system may include a communication device configured for receiving a request to obtain a stock in a social value associated with a first user account. Further, the request may be received from a second user device associated with a second user account. Further, the system may include a processing device configured for assigning a portion of the social value of the first user account to the second user account based on the request. In some embodiments, the portion of the social value of the first user account may be limited to a predefined level. Further, the processing device may be configured for determining earnings associated with the first user account. Further, the processing device may be configured for transferring a dividend to the second user account based on the earnings associated with the first user account.

In further embodiments, the communication device may be further configured for transmitting the request to a first user device associated with the first user account and receiving an authorization from the first user device. Further, assigning the portion of the social value of the first user account to the second user account may be further based on the authorization.

In some embodiments, the processing device may be further configured for monitoring user activity data corresponding to at least one user activity associated with the first user account, analyzing the user activity data and determining the earnings associated with the first user account based on the analyzing. The at least one user activity may include one or more of an online activity and an offline activity. In further embodiments, the communication device may be further configured for receiving the user activity data from a wearable device associated with the first user account.

In some embodiments, the processing device may be further configured for monitoring user activity data corresponding to at least one user activity associated with the first user account, analyzing the user activity data and generating an updated social value based on the analyzing and the social value associated with the first user account. Further, the system further may include a storage device configured for storing the updated social value in association with the first user account.

In some embodiments, the communication device may be further configured for transmitting a stock holding associated with the second user account to a third user device, and receiving a stock purchase request from the third user device. Further, the stock purchase request may be associated with the stock holding. Further, the processing device may be further configured for assigning a part of the stock holding associated with the second user account to a third user account associated with the third user device.

In some embodiments, the communication device may be further configured for receiving a request to add an advertisement to a profile of the first user account, receiving a one-time access fee based upon adding the advertisement to the profile, and receiving a watch and earn price associated with the advertisement. Further, the processing device may be further configured for determining viewing of the advertisement by at least one user socially connected to the first user account, and generating an updated social value based on the viewing and the watch and earn price. Further, the system further may include a storage device configured for storing the updated social value in association with the first user account.

In some embodiments, the communication device may be further configured for receiving a chat request from a third user device. Further, the chat request may be directed to a first user associated with the first user account. Further, the communication device may be configured for receiving payment associated with the social value of the first user account. Further, the payment may be received from the third user device. Yet further, the communication device may be configured for transferring the chat request to the first user device based on receiving the payment, receiving a response from the first user device and transmitting the response to the third user device.

FIG. 7 is an exemplary visualization of managing of the social value of a social user account based on sensor data corresponding to a user activity (online and/or offline activity) of a user 702, in accordance with some embodiments. Accordingly, the online platform 100 may be configured to communicate, using the communication device, with a monitoring device, such as, for example, a wearable sensor 704 (for example, a fitness band). Accordingly, the online platform 100 may gather sensor data received from the wearable sensor 704 and assign the social value associated with an activity.

In an instance, integration of the online platform 100 with the wearable sensor 704 may assist in tracking of offline activities. For example, the online platform 100 may track the offline activity of a first user, such as participation in a marathon. In an instance, a second user may have bought stocks in the first registered user, who may be an athletic professional. Further, the athletic professional (the first user) may be participating in the marathon. Accordingly, the online platform 100 may track details such as speed and rank of the athletic professional etc. Further, the online platform 100 may reward the athletic professional based upon the performance of the athletic professional in the marathon. Accordingly, the reward may update the social value (e.g. social stock price) on the online platform 100. Further, earning gained from rewards for participating and/or winning the marathon may be proportionately divided (based on the extent of shares sold to the second user) between the first user as well as the second user.

Further, according to some aspects, the online platform 100 may communicate with other online platforms that reward users for performing physical activities like yoga, running, jogging, etc. In an instance, the other online platforms may also communicate with the wearable sensors like fitness bands in order to track the physical activities performed by the user. Further, based upon tracking of the physical activity, the other online platforms may add a reward to an associated user account. Accordingly, the other online platform may send a reward report to the system and/or the online platform. Further, based upon the reward report received, the system may update the social value associated with a corresponding user account.

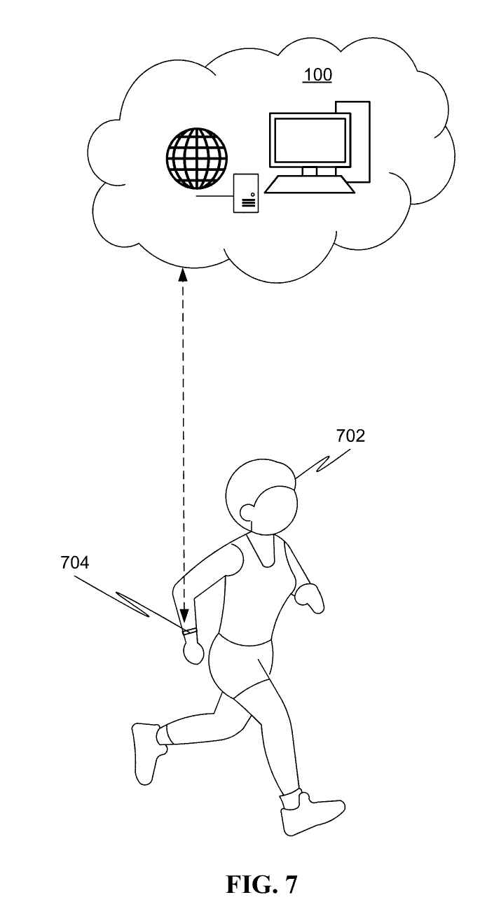

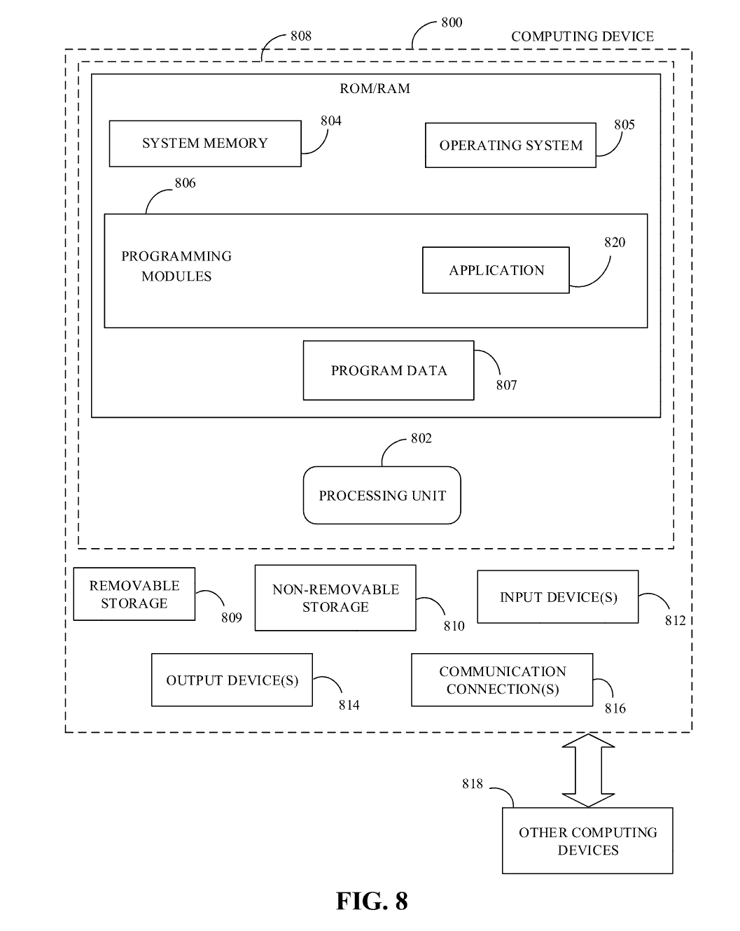

FIG. 8 is a block diagram of a computing device for implementing the methods disclosed herein, in accordance with some embodiments. Consistent with an embodiment of the disclosure, the aforementioned storage device and processing device may be implemented in a computing device, such as computing device 800 of FIG. 8. Any suitable combination of hardware, software, or firmware may be used to implement the memory storage and processing unit. For example, the storage device and the processing device may be implemented with computing device 800 or any of other computing devices 818, in combination with computing device 800. The aforementioned system, device, and processors are examples and other systems, devices, and processors may comprise the aforementioned storage device and processing device, consistent with embodiments of the disclosure.

With reference to FIG. 8, a system consistent with an embodiment of the disclosure may include a computing device or cloud service, such as computing device 800. In a basic configuration, computing device 800 may include at least one processing unit 802 and a system memory 804. Depending on the configuration and type of computing device, system memory 804 may comprise, but is not limited to, volatile (e.g. random access memory (RAM)), non-volatile (e.g. read-only memory (ROM)), flash memory, or any combination. System memory 804 may include operating system 805, one or more programming modules 806, and may include a program data 807. Operating system 805, for example, may be suitable for controlling computing device 800's operation. Furthermore, embodiments of the disclosure may be practiced in conjunction with a graphics library, other operating systems, or any other application program and is not limited to any particular application or system. This basic configuration is illustrated in FIG. 8 by those components within a dashed line 808.

Computing device 800 may have additional features or functionality. For example, computing device 800 may also include additional data storage devices (removable and/or non-removable) such as, for example, magnetic disks, optical disks, or tape. Such additional storage is illustrated in FIG. 8 by a removable storage 809 and a non-removable storage 810. Computer storage media may include volatile and nonvolatile, removable and non-removable media implemented in any method or technology for storage of information, such as computer-readable instructions, data structures, program modules, or other data. System memory 804, removable storage 809, and non-removable storage 810 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 800. Any such computer storage media may be part of device 800. Computing device 800 may also have input device(s) 812 such as a keyboard, a mouse, a pen, a sound input device, a touch input device, etc. Output device(s) 814 such as a display, speakers, a printer, etc. may also be included. The aforementioned devices are examples and others may be used.

Computing device 800 may also contain a communication connection 816 that may allow device 800 to communicate with other computing devices 818, such as over a network in a distributed computing environment, for example, an intranet or the Internet. Communication connection 816 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 804, including operating system 805. While executing on processing unit 802, programming modules 806 (e.g., application 820 such as a media player) may perform processes including, for example, one or more stages of methods 200-600, algorithms, systems, applications, servers, databases as described above. The aforementioned process is an example, and processing unit 802 may perform other processes. Other programming modules that may be used in accordance with embodiments of the present disclosure may include sound encoding/decoding applications, machine learning application, acoustic classifiers etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

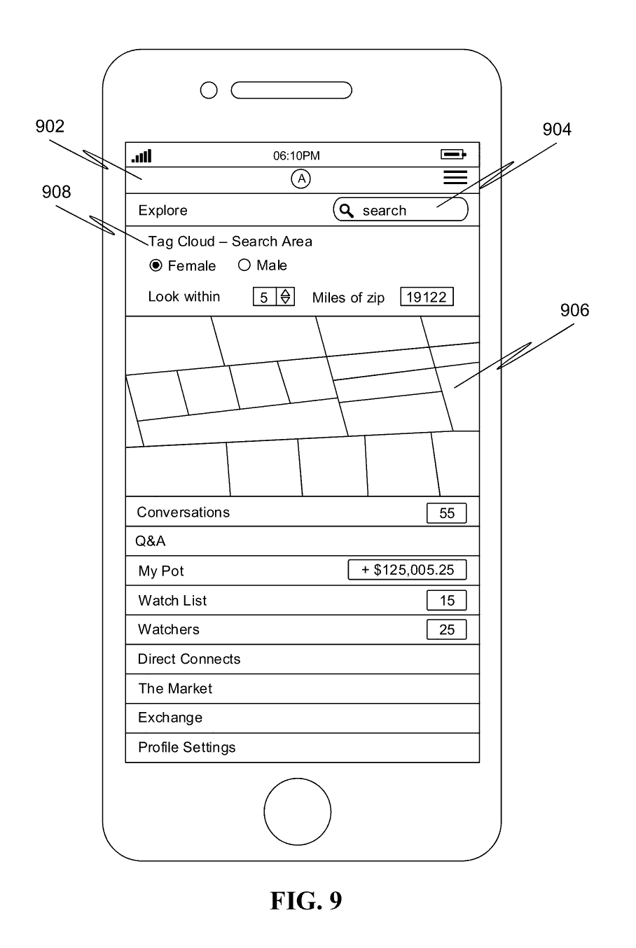

FIG. 9 illustrates a user interface 902 of a mobile application for managing social value of one or more user accounts, in accordance with some embodiments. The user interface 902 includes a menu to explore and search for users at a particular location and/or associated with a specified social stock value (or range of values). In an exemplary embodiment, the user interface provides an option to explore users at a particular location may include a search box 904 and a map based display 906. Further, in an instance, a user may enter a search query in the search box 904 and subsequently provide other search preferences, such as, for example, search preferences based on gender, age, race, profession etc. According to some aspects, the user may enter a zip code in the search box 904. In an embodiment, the user may also filter search results based upon the social value associated with a user.

In some embodiments, the user may also provide the search query in the form of keywords associated with a user and/or the user profile. For example, the search query may include a string of keywords such as, for example, fitness, science, design, etc. Accordingly, the mobile application may search users who are associated with the keywords provided. In an instance, the mobile application may show the users on the map based display. Further, the users on the map-based display may be displayed in the form of user-pin based representation wherein each user pin represents a user.

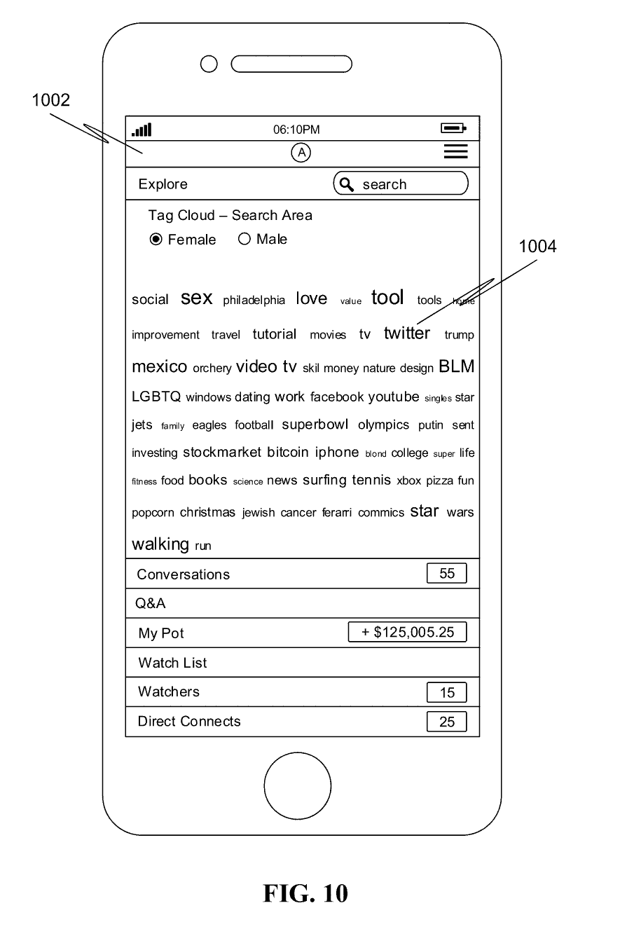

Further, the user interface 902 provides a tag cloud option 908. If the user selects the tag cloud option 908, the mobile application may show the user interface 1002 shown in FIG. 10. The user interface 1002 includes a tag cloud 1004 which depicts keywords searched by the user. The font size of the various keywords may represent the prominence or frequency of the keywords depicted.

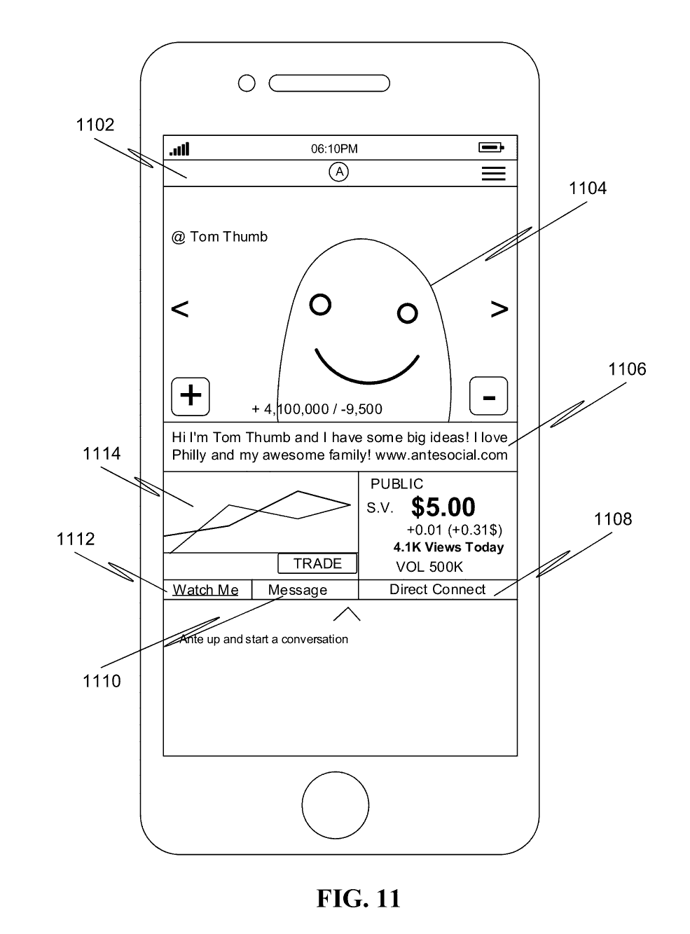

FIG. 11 illustrates a user interface 1102 of the mobile application displaying a user profile based upon the search query, in accordance with exemplary embodiments. In an instance, the mobile application may present search results, which include a thumbnail 1104 of user profiles associated with the search query provided by the user. Accordingly, the thumbnail 1104 may include a display picture of a user profile. Further, the thumbnail 1104 may also include an introductory statement and/or the bio statement 1106 as listed by a user on the user profile.

Further, the user may click on the thumbnail 1104 showing the user profile in order to expand the user profile. In an instance, on expanding the user profile, the mobile application may present a user interface that includes various options such as, for example, direct connect 1108, message 1110, watch me 1112, etc. According to some aspects, the user profile may also present a social value graph 1114 that displays the variation of the social stock price over the time. In an instance, the social value graph 1114 may be termed as social stock vs time distribution graph.

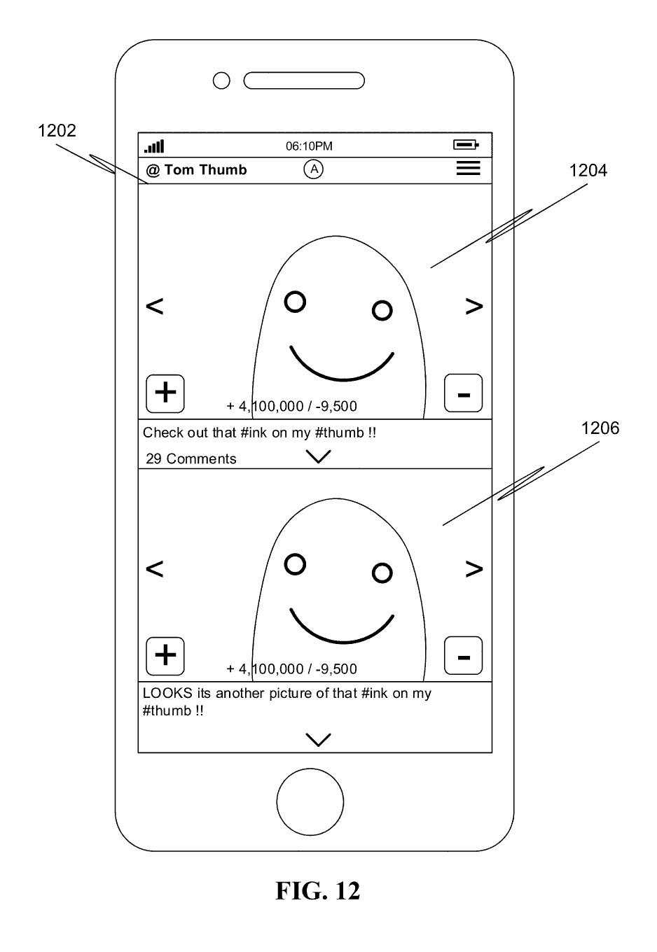

In an instance, on expanding the user profile, the mobile application may present a user interface 1202 comprising a timeline of the user as shown in FIG. 12. The timeline may include one or more posts 1204-1206.

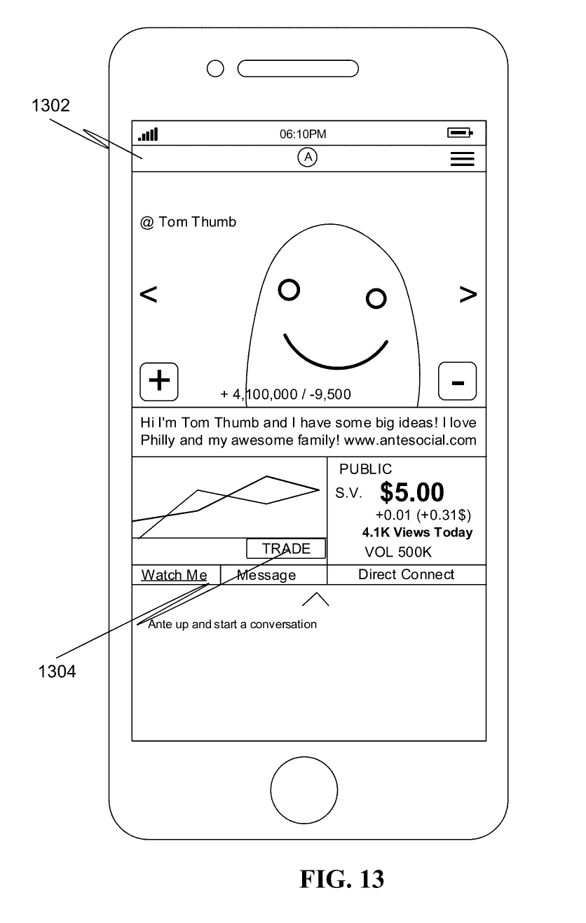

FIG. 13 illustrates a user interface 1302 of the mobile application displaying a trade button 1304 that allows a user to trade social stocks in a user, in accordance with some embodiments. When the trade button 1304 is clicked, the mobile application may open a box that allows a second user to buy and/or sell the social stocks in a first user.

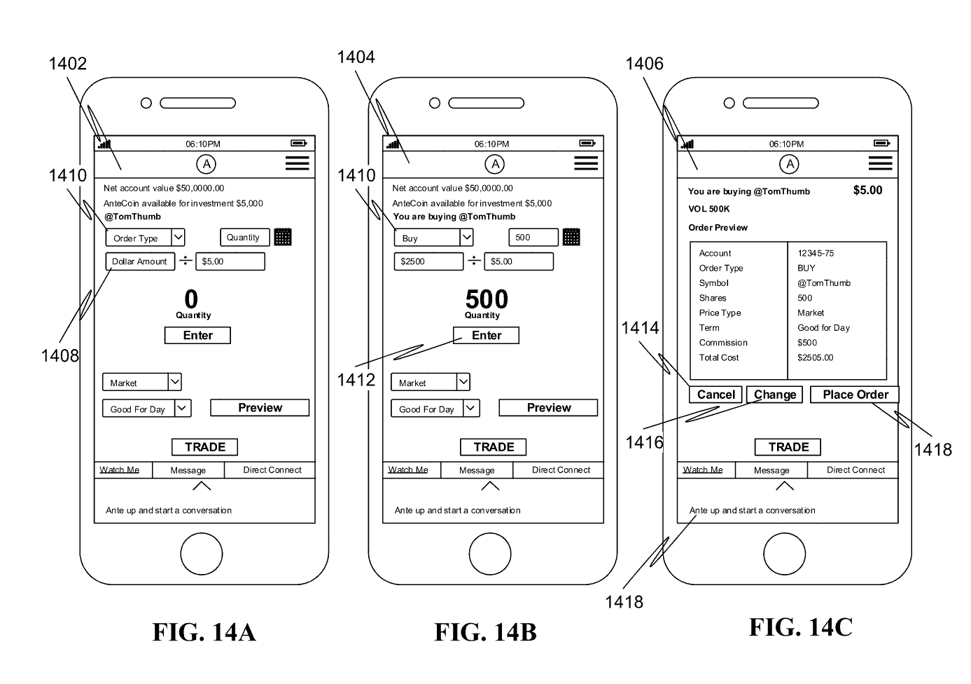

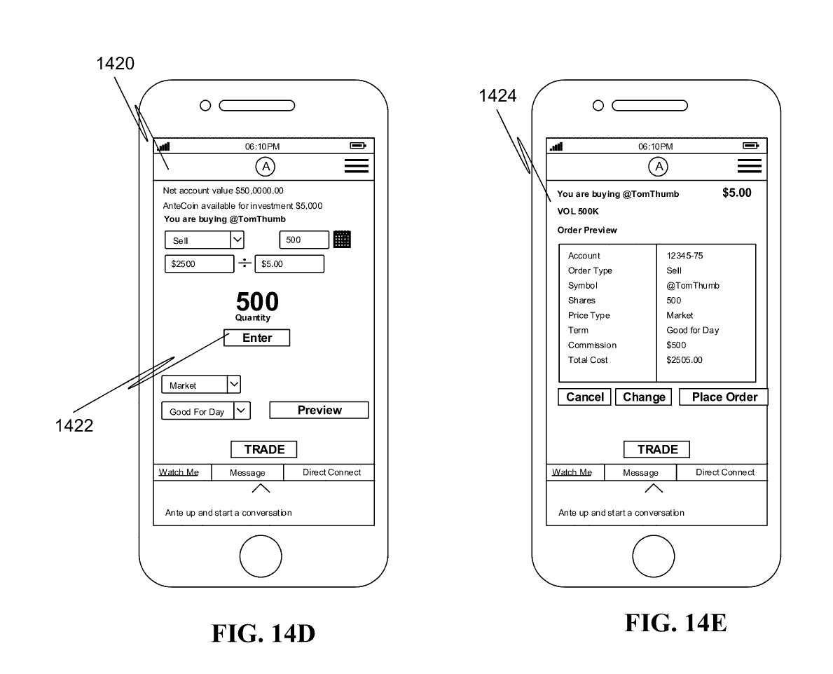

FIGS. 14A-C illustrate user interface 1402-1406 of the mobile application for buying social stocks in a user, in accordance with some embodiments. In an embodiment, when a user clicks on the trade button 1304, the mobile application may present the user interface 1402 containing a preview page. The preview page includes details such as, the social stock price associated with a user, newt account value of a user, social stock available for buying etc. In an instance, the user interface may also include a calculator 1408 that calculates the quantity and/or number of shares that the user can buy and/or sell against an investment amount.

The user may select an order type by using the drop down menu 1410. The order type may include bull and sell. If the user selects the buy order type, then the mobile application may present the user interface 1404 containing a buy page. For example, if the social stock price is listed as $5, and the investment amount is equal to $2500, then the user may buy and/or sell a maximum of 500 shares. Then the user may activate an enter button 1412 and in response, the mobile application may present the user interface 1406 containing an order confirmation page. Thereafter, the user may cancel the order (by using a cancel button 1414), change the order (by using a change button 1416) and place the order (by using a place order button 1418).

In an exemplary embodiment, the user may click on an AnteUp button 1418 and start a conversation with a user. Further, the user may also be provided with an option to select market.

If the user selects the sell order type on the drop down menu 1410, then the mobile application may present the user interface 1420 containing a sell page shown in FIG. 14D. In an instance, sell option may only appear if the second user has a stock in the first user. Accordingly, the second user may sell a portion of stocks in the first user to a third user. Thereafter, the user may select the number of shares to sell and activate an enter button 1422 and in response, the mobile application may present the user interface 1424 containing an order confirmation page.

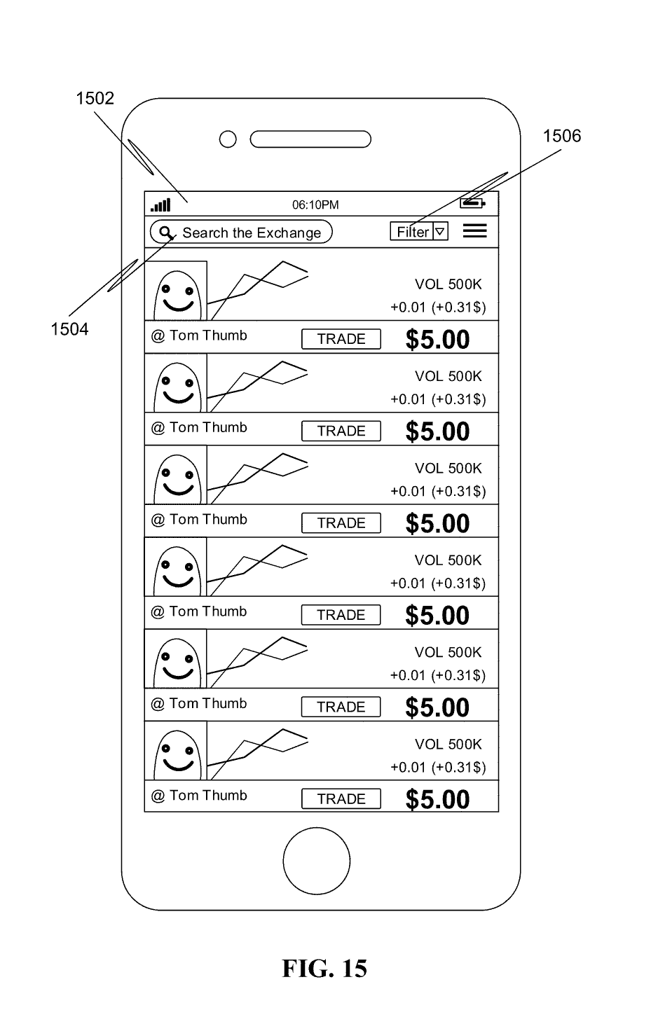

FIG. 15 illustrates a user interface 1502 of the mobile application for filtering search results, in accordance with some embodiments. In an instance, the user interface 1502 may include a search box 1504 that may be used to search for an exchange rate associated with a user. Further, the user interface 1502 may also include a filter option 1506, wherein the user may sort a list of users on the basis of filters such as, for example, top performing, most traded, new stocks etc. Further, the user interface 1502 may display search results based on search criteria and filters selected by the user.

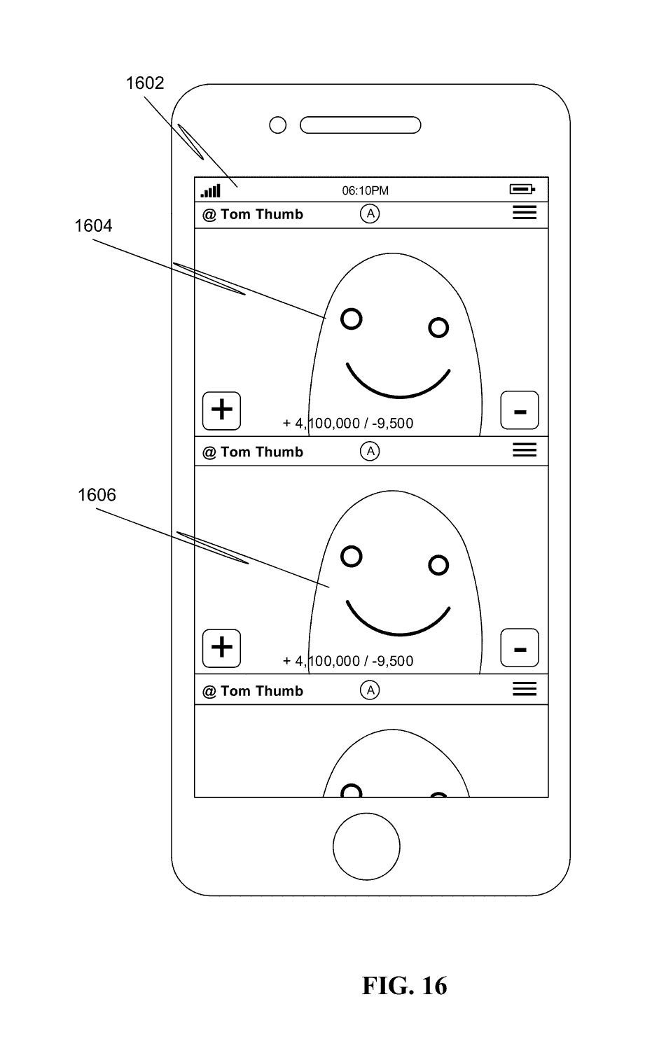

FIG. 16 illustrates a user interface 1602 of the mobile application for displaying results based on applying a filter, in accordance with some embodiments. In an instance, the mobile application may filter search results based upon contextual data such as, exchange rate, top performing users, most traded users etc. Further, the mobile application may present filtered search results accordingly. The search results may include thumbnail-based images 1604-1606 of the users that further include an icon, which upon being clicked, expounds the user profile.

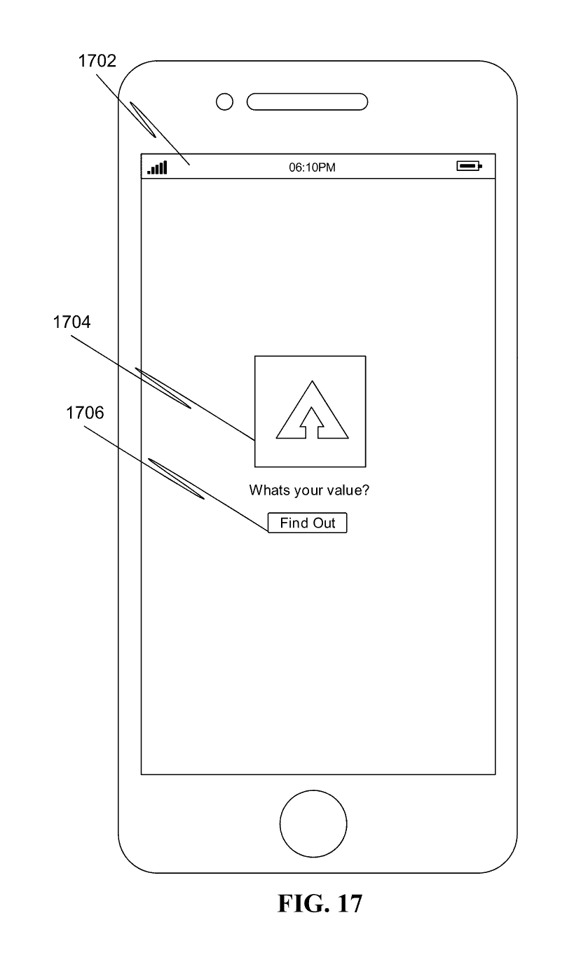

FIG. 17-20 illustrates a user interface of the application displaying login and/or an account creation process for a new user including specifying portion of social stock to be provided for purchase by other users, in accordance with some embodiments.

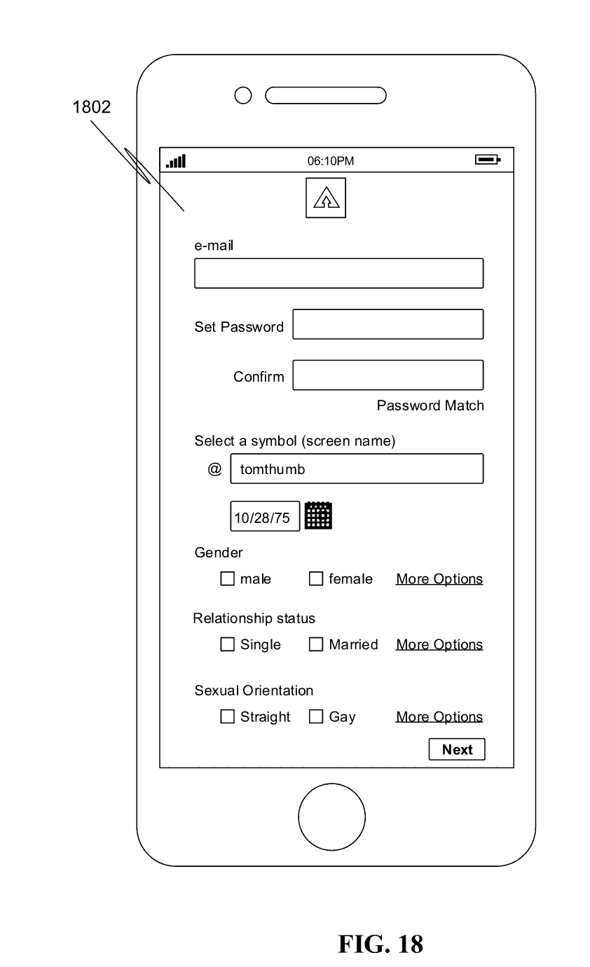

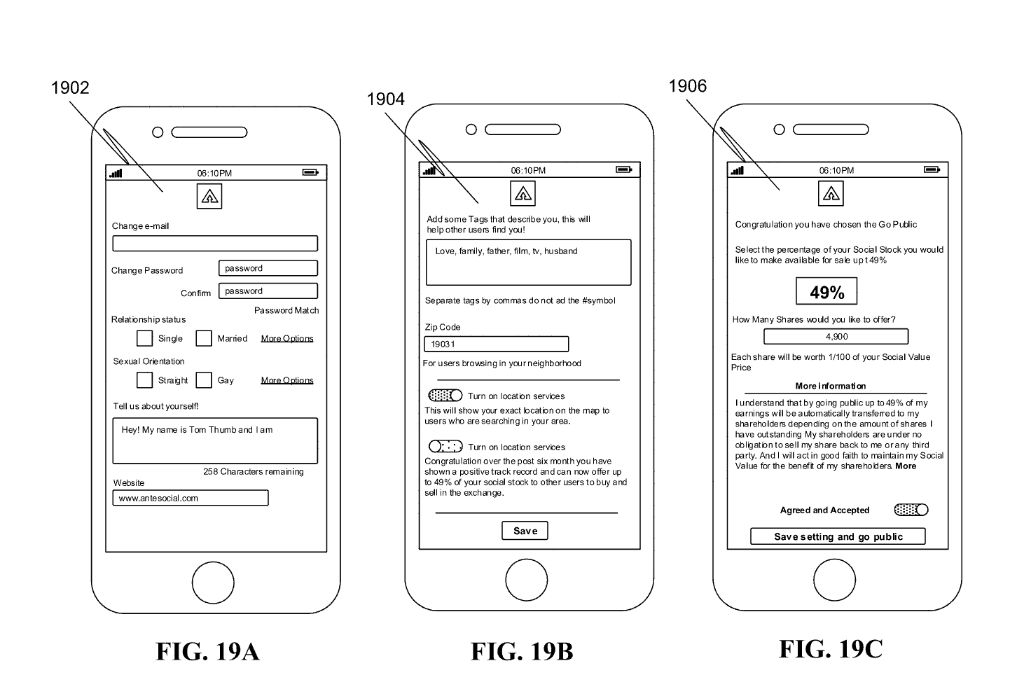

FIG. 17 illustrates a user interface 1702 containing a login page, in accordance with some embodiments. The user interface 1702 may include an icon 1704 that says, “Find your Value”. Further, a new user may click on the “Find your Value” icon 1704 in order to register on the online platform 100 through the mobile application. In an embodiment, upon clicking a “Find Out” button 1706, the new user may be requested to enter details such as, email address, password, user name, profile symbol, gender, relationship status etc. on a user interface 1802 shown in FIG. 18 or on a user interface 1902 in FIG. 19A.

Further, in some embodiments, the new user may also provide keywords to link with her profile using a user interface 1904 shown in FIG. 19B. In an instance, the keywords may be provided in the form of hashtags. The keywords may help other users to search for profiles associated with particular keyword(s).

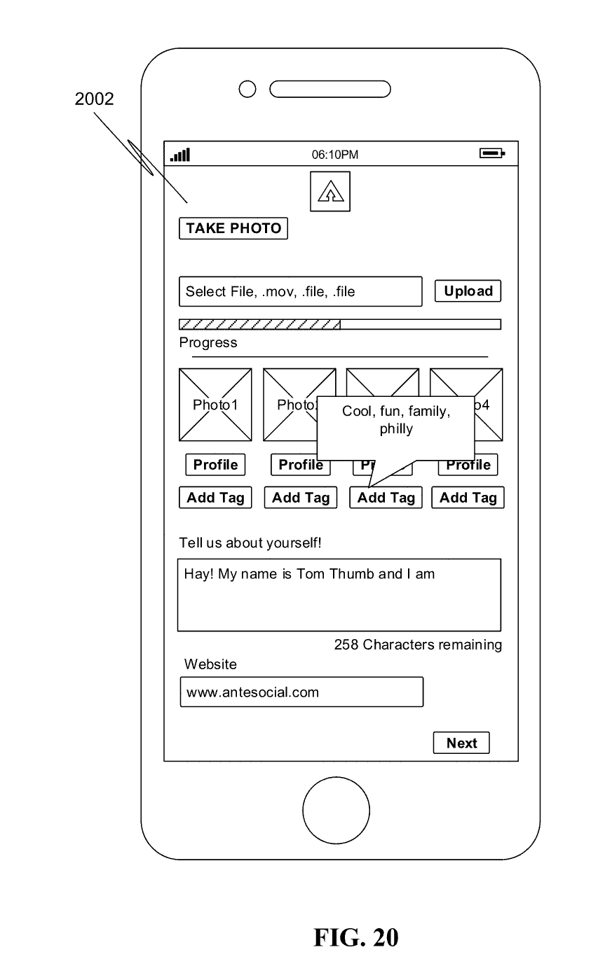

Further, the new users may be given an option to “Go Public” only after the new users have satisfied terms and conditions as put forward by the application. In an instance, the option to “Go Public” may be provided on a user interface 1906 shown in FIG. 19. The option to “Go Public” may represent the permission to offer the social stock to other users of the online platform 100. Accordingly, the new user may complete at least six months on the online platform 100 and show growth before an option to “Go Public” and/or option to offer stock is available. In an embodiment, choosing to go public may expand user profile to include public parameters. Further, the new users may set a display picture to be displayed to the other users on the online platform 100 via a user interface 2002 shown in FIG. 20. The new user may also provide permission to the application in order to access the location associated with the user device operated by the new user.

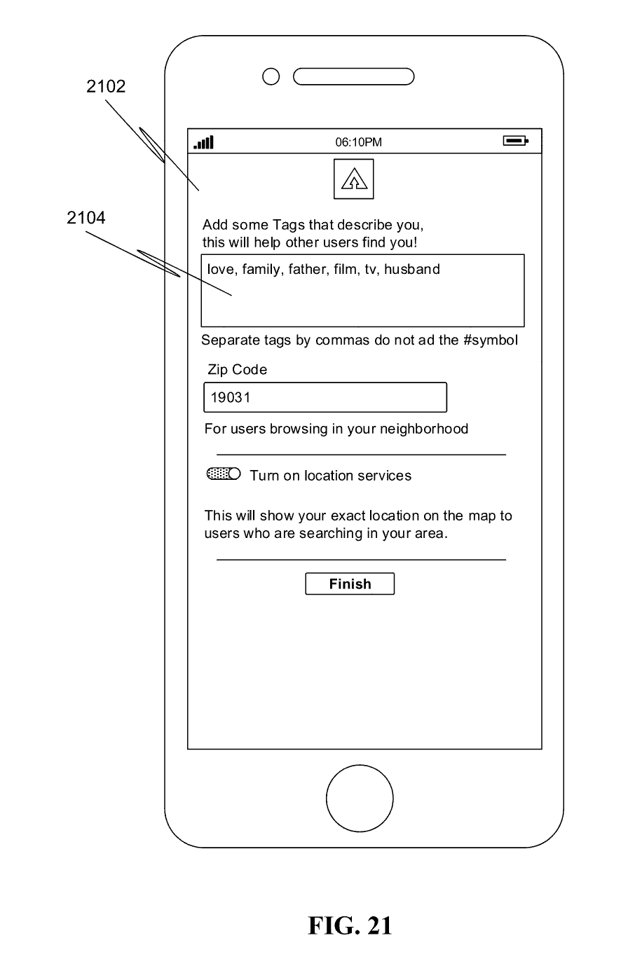

FIG. 21 illustrates a user interface 2102 of the mobile application for optimizing user search based on adding user tags, in accordance with some embodiments. In an instance, while creating a profile on the mobile application, the new user may add tags related to her profile in a text area 2104. The new user may add tags to ensure that the other users may be able to search for the profile of the new user by entering tags in the search box.

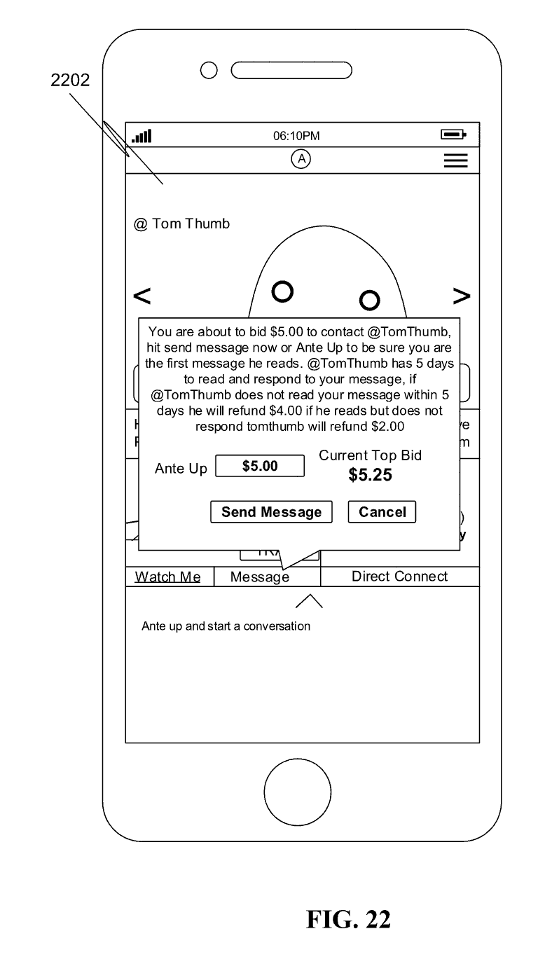

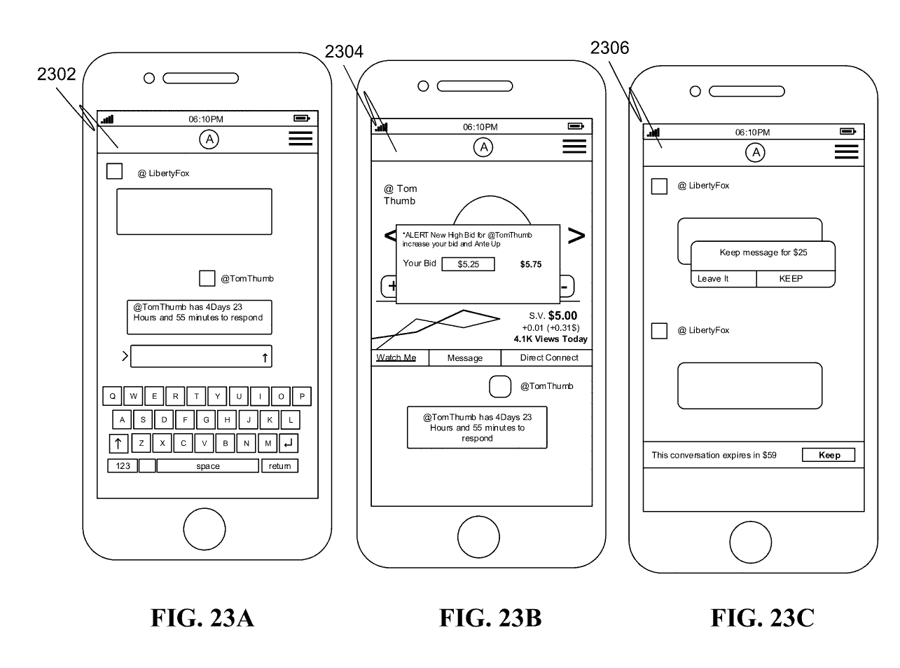

FIGS. 22, 23A-C illustrate user interfaces 2202, 2302-2306 of the mobile application for sending an instant message to a user based on bidding and social stock value, in accordance with some embodiments. In an instance, a second user may send a message to a first user by bidding an amount equivalent to the social stock price listed on the social user account associated with the first user. For example, if the user B wants to message user A whose social stock price is equal to $5, then the user B has to pay five dollars ($5) in order to contact the user A. Further, the user interface also displays the highest bid associated with the profile of the first user. In an embodiment, the first user may have pre-determined number of days (e.g. 5) to respond to a message sent by the second user. Further, the system may refund a portion of bidding amount if the first user does not read and/or respond to the message sent by the second user. Further, if either user wishes to store the message before the system deletes it after the pre-determined time, either user may have an option to keep the message by paying an additional amount as shown in the user interface 2306.

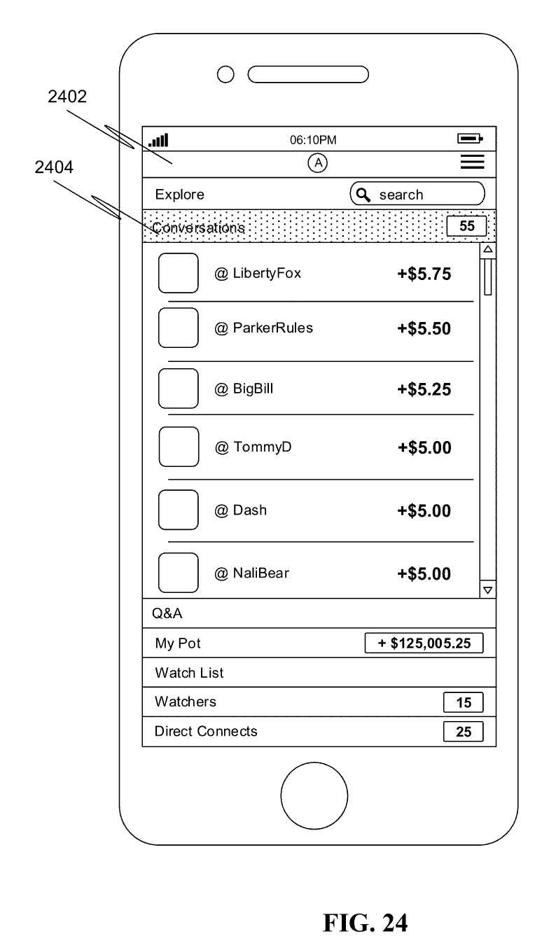

FIG. 24 illustrates a user interface 2402 of the mobile application for viewing recent user conversations, in accordance with some embodiments. In an instance, the mobile application may include an option 2404 called, “Conversation”, which upon being clicked, displays a list of recent conversation and/or exchange of messages between the first user and the second user. Further, the recent user conversation may also list the current social value of the second user.

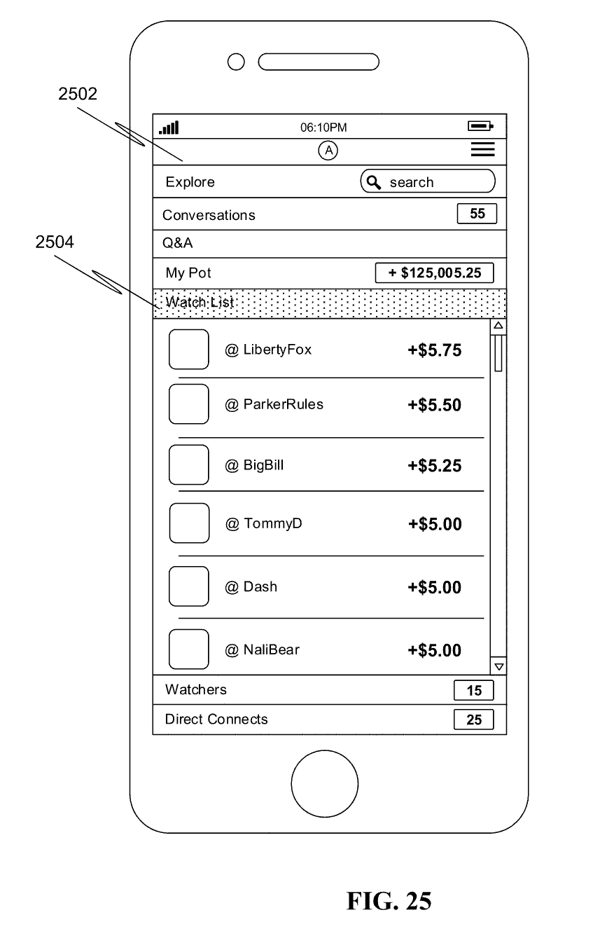

FIG. 25 illustrates a user interface 2502 of the mobile application for viewing a watch list 2504 associated with user profiles, in accordance with some embodiments. In an instance, the watch list 2504 may display users profile, images and social value. The watch list 2504 may be scrollable. In scrollable watch list, a number of user profiles may appear as thumbnails. Accordingly, the thumbnails may display notifications based in recent activity of a user. For example, if the user A has uploaded five new images, then the watch list 2504 may show the recent user activity (added five new images) in the thumbnail profile associated with the user A.

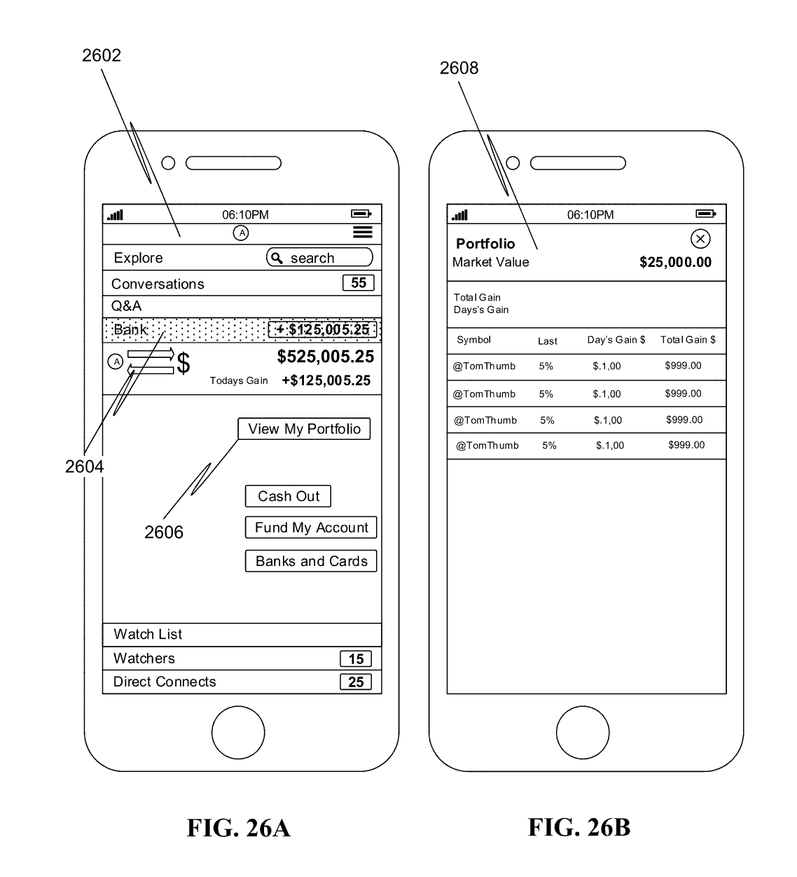

FIG. 26A illustrates a user interface 2602 of the mobile application for viewing account balance associated with a user account, in accordance with some embodiments. In an instance, the profile of a user may include an option 2604 called, “Bank”, which upon being clicked, displays the updated account balance associated with the user account. In an instance, the format of the account balance may be interchanged between AnteCoin and Dollars. Further, there may be icons representing Dollar format as well as the AnteCoin format. Accordingly, a user may click on an interchange icon positioned between the Dollar icon and the AnteCoin icon in order to change the format of account balance. For example, if the account balance is initially displayed in Dollar format, them the user may click on the interchange icon to convert the amount into the AnteCoin format. Further, the user may select a view my portfolio 2606 to view the portfolio of shares. In response, the mobile application may display a user interface 2608.

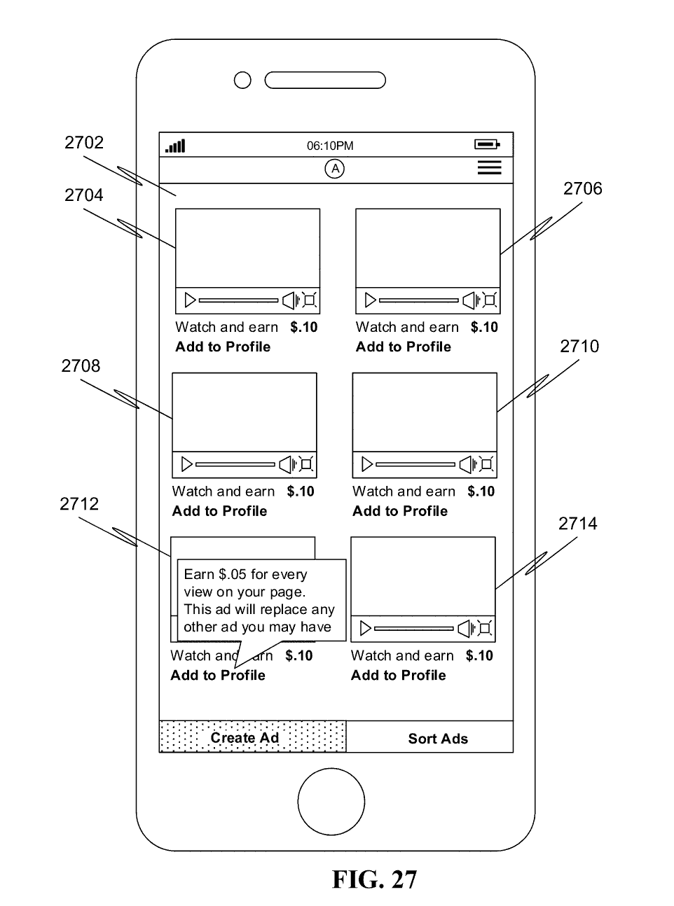

FIG. 27 illustrates a user interface 2702 of the mobile application displaying a market where users can go to watch advertisements 2704-2714 in accordance with some embodiments. Accordingly, any user who watches the advertisement may be paid an amount equivalent to the watch and earn price associated with the advertisement.

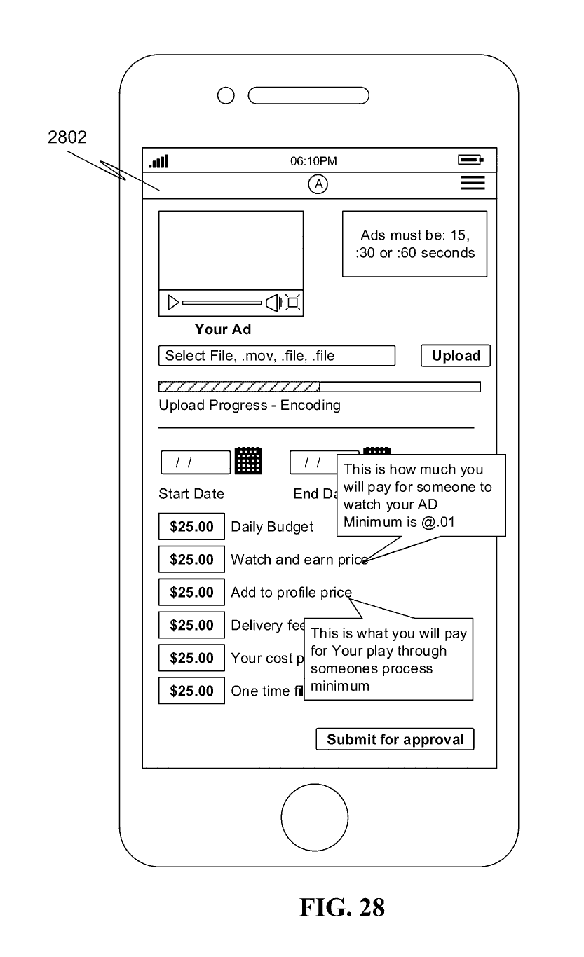

FIG. 28 illustrates a user interface 2802 of the mobile application displaying a self-serve process page that an advertiser may use to place advertisements in accordance with some embodiments. Further, along with business rules, the add to profile price may represent an amount that an advertiser may pay to a user for every view of an advertisement that is placed in that user's profile as indicated in the confirmation dialog box (as shown in FIG. 27).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

What is claimed is:

1. A method of managing a social value of at least one social user account, the method comprising:
receiving, using a communication device, a request to obtain a stock in a social value associated with a first user account, wherein the request is received from a second user device associated with a second user account;
assigning, using a processing device, a portion of the social value of the first user account to the second user account based on the request;
determining, using the processing device, earnings associated with the first user account; and
transferring, using the processing device, a dividend to the second user account based on the earnings associated with the first user account.

2. The method of claim 1, wherein the portion of the social value of the first user account is limited to a predefined level.

3. The method of claim 1 further comprising:
transmitting, using the communication device, the request to a first user device associated with the first user account; and
receiving, using the communication device, an authorization from the first user device, wherein assigning the portion of the social value of the first user account to the second user account is further based on the authorization.

4. The method of claim 1 further comprising:
monitoring, using the processing device, user activity data corresponding to at least one user activity associated with the first user account;
analyzing, using the processing device, the user activity data; and
determining, using the processing device, the earnings associated with the first user account based on the analyzing.

5. The method of claim 4, wherein the at least one user activity comprises at least one of an online activity and an offline activity.

6. The method of claim 4 further comprising receiving, using the communication device, the user activity data from a wearable device associated with the first user account.

7. The method of claim 1 further comprising:
monitoring, using the processing device, user activity data corresponding to at least one user activity associated with the first user account;
analyzing, using the processing device, the user activity data;
generating, using the processing device, an updated social value based on the analyzing and the social value associated with the first user account; and
storing, using a storage device, the updated social value in association with the first user account.

8. The method of claim 1 further comprising:
transmitting, using the communication device, a stock holding associated with the second user account to a third user device;
receiving, using the communication device, a stock purchase request from the third user device, wherein the stock purchase request is associated with the stock holding; and
assigning, using the processing device, a part of the stock holding associated with the second user account to a third user account associated with the third user device.

9. The method of claim 1 further comprising:
receiving, using the communication device, a request to add an advertisement to a profile of the first user account;
receiving, using the communication device, a one-time access fee based upon adding the advertisement to the profile;
receiving, using the communication device, a watch and earn price associated with the advertisement;
determining, using the processing device, viewing of the advertisement by at least one user socially connected to the first user account;
generating, using the processing device, an updated social value based on the viewing and the watch and earn price; and
storing, using a storage device, the updated social value in association with the first user account.

10. The method of claim 1 further comprising:
receiving, using the communication device, a chat request from a third user device, wherein the chat request is directed to a first user associated with the first user account;
receiving, using the communication device, a payment associated with the social value of the first user account, wherein the payment is received from the third user device;
transferring, using the communication device, the chat request to the first user device based on receiving the payment;
receiving, using the communication device, a response from the first user device; and
transmitting, using the communication device, the response to the third user device.

11. A system for managing a social value of at least one social user account, the system comprising:
a communication device configured for receiving a request to obtain a stock in a social value associated with a first user account, wherein the request is received from a second user device associated with a second user account; and
a processing device configured for:
assigning a portion of the social value of the first user account to the second user account based on the request;
determining earnings associated with the first user account; and
transferring a dividend to the second user account based on the earnings associated with the first user account.

12. The system of claim 11, wherein the portion of the social value of the first user account is limited to a predefined level.

13. The system of claim 11, wherein the communication device is further configured for:
transmitting the request to a first user device associated with the first user account; and
receiving an authorization from the first user device, wherein assigning the portion of the social value of the first user account to the second user account is further based on the authorization.

14. The system of claim 11, wherein the processing device is further configured for:
monitoring user activity data corresponding to at least one user activity associated with the first user account;
analyzing the user activity data; and
determining the earnings associated with the first user account based on the analyzing.

15. The system of claim 14, wherein the at least one user activity comprises at least one of an online activity and an offline activity.

16. The system of claim 14, wherein the communication device is further configured for receiving the user activity data from a wearable device associated with the first user account.

17. The system of claim 11, wherein the processing device is further configured for:
monitoring user activity data corresponding to at least one user activity associated with the first user account;
analyzing the user activity data; and
generating an updated social value based on the analyzing and the social value associated with the first user account, wherein the system further comprises a storage device configured for storing the updated social value in association with the first user account.

18. The system of claim 11, wherein the communication device is further configured for:
transmitting a stock holding associated with the second user account to a third user device; and
receiving a stock purchase request from the third user device, wherein the stock purchase request is associated with the stock holding, and wherein the processing device is further configured for assigning a part of the stock holding associated with the second user account to a third user account associated with the third user device.

19. The system of claim 11, wherein the communication device is further configured for:
receiving a request to add an advertisement to a profile of the first user account;
receiving a one-time access fee based upon adding the advertisement to the profile; and
receiving, a watch and earn price associated with the advertisement, wherein the processing device is further configured for:
determining viewing of the advertisement by at least one user socially connected to the first user account; and
generating an updated social value based on the viewing and the watch and earn price, wherein the system further comprises a storage device configured for storing the updated social value in association with the first user account.

20. The system of claim 11, wherein the communication device is further configured for:
receiving a chat request from a third user device, wherein the chat request is directed to a first user associated with the first user account;
receiving payment associated with the social value of the first user account, wherein the payment is received from the third user device;
transferring the chat request to the first user device based on receiving the payment;
receiving a response from the first user device; and
transmitting the response to the third user device.
